(19) United States
(12) Patent Application Publication
(10) Pub. No.: US 2004/0185237 A1
(43) Pub. Date: Sep. 23, 2004

(54) Sheet for sealing electrical wiring

(76) Inventor: Kohichiro Kawate, Machida-city (JP)

Correspondence Address: 3M INNOVATIVE PROPERTIES COMPANY, PO BOX 33427, ST. PAUL, MN, 55133-3427, US

(21) Appl. No.: 10/484,117

(22) PCT Filed: Aug. 6, 2002
(86) PCT No.: PCT/US02/24789

(30) Foreign Application Priority Data
Aug. 7, 2001 (JP) 2001-239204

(51) Int. Cl. B32B 3/00

(52) U.S. Cl. 428/216

(57) ABSTRACT

A sheet for sealing bus-bar comprising a thermoplastic resin layer having a thickness of not less than 300 μm, and a thermocurable resin layer having a thickness of not more than 100 μm placed on one surface thereof.

### FIELD OF THE INVENTION

The present invention relates to an insulating material used for sealing electric wiring, particularly an insulating material used for sealing fine electric wiring formed on a semiconductor device.

### DESCRIPTION OF RELATED ART

In a resin-sealed type semiconductor device, fine electric wiring which is complicatedly arranged is sealed with a resin, which is an insulating material, to prevent an unintended short circuit. A large quantity of electric current flows particularly into bus-bars used for supplying a given voltage to a semiconductor device, such as a power supply or a ground; therefore, it is required to seal this securely.

Hitherto, a thermocurable resin has been used, as it is, as an insulating material for sealing such electric wiring. However, the thermocurable resin has fluidity and viscosity in an uncured state. When this is used as is for the electric wiring sealing material, the next step cannot be performed until the thermocurable resin cures completely to turn into a non-adhesive solid. Thus, the production process is delayed. Moreover, it is difficult to completely prevent outflowing or swelling of the thermocurable resin. Thus, the integrity of the sealing is apt to become uncertain. Further, the thermocurable resin has relatively high hygroscopicity (1% or more), so moisture easily permeates the resin, and insulating property thereof is poor and the wiring is easily corroded.

In recent years, package LSIs have been required to be made particularly small-sized, thin and inexpensive, so that it is necessary to seal the wiring through a surer and simpler step. It is desired to overcome the drawbacks of the thermocurable resin.

The present invention solves the above-mentioned problems in the prior art, and an object thereof is to provide a sheet for sealing one or more bus-bars making it possible to seal the bus-bars securely through a simple step.

### SUMMARY OF THE INVENTION

The present invention is to provide a sheet for sealing bus-bars comprising a thermoplastic resin layer having a thickness of not less than 300 μm, and a thermocurable resin layer having a thickness of not more than 100 μm formed on one surface thereof. This can attain the above-mentioned object.

### BRIEF DESCRIPTION OF THE DRAWINGS

FIG. 1 is a sectional view of a sheet for sealing bus-bars of the present invention.

FIG. 2 is a perspective view which schematically illustrates the step of sealing bus-bars.

FIG. 3 is a perspective view of a structural body wherein bus-bars are sealed with the sheet for sealing bus-bars of the present invention.

### EXPLANATION OF NUMERALS

1 . . . thermoplastic resin layer.

2 . . . thermocurable resin layer.

3 . . . glass plate.

4 . . . bus-bars.

### DETAILED DESCRIPTION OF THE INVENTION

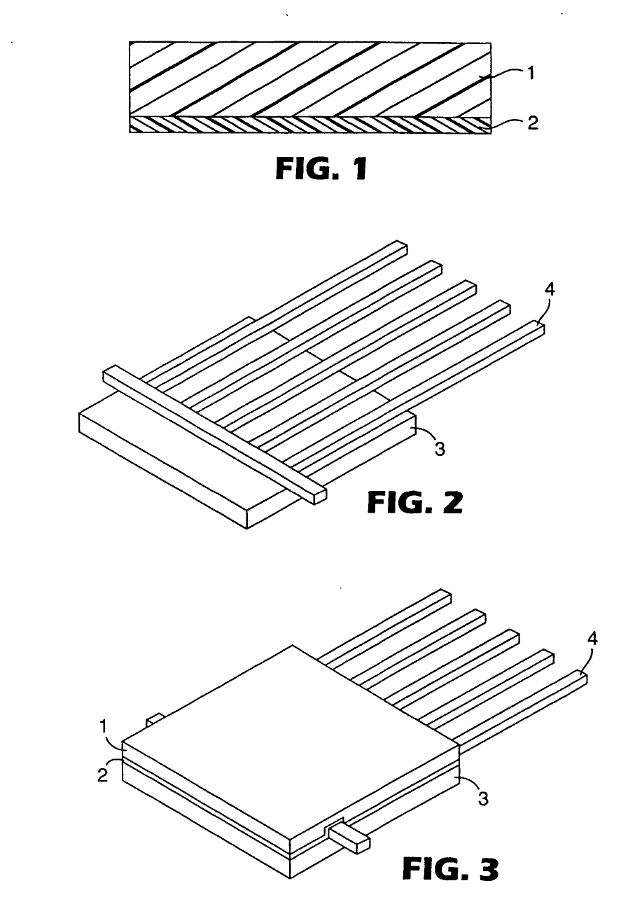

FIG. 1 is a sectional view of a sheet for sealing bus-bars of the present invention. A thermocurable resin layer 2 is formed on one surface of a thermoplastic resin layer 1.

The thermoplastic resin layer is made of a thermoplastic resin. The thermoplastic resin should be a material which is a flexible solid at room temperature but has such a fluidity that causes the resin in case of being heat-pressed together with bus-bars to flow so that bus-bars can be concealed. Preferred examples of the thermoplastic resin include polyester, polyolefin, EVA, ethylene acrylate copolymer, acrylic resin, fluorine resin and polyether.

It is generally preferred to use the thermoplastic resin subjected to drawing or the like and processed into a film form. This is because the production process of the sheet for sealing bus-bars becomes simple. As the thermoplastic resin film, a commercially available film may be used. For example, as the polyester, a polyethylene terephthalate film (trade named “6010”) manufactured by Takiron K.K. or the like can be used.

The thickness of the thermoplastic resin layer is appropriately adjusted in such a manner that the resin flows when heat-pressed so that bus-bars can be covered completely and sealed securely. In general, the thickness of the thermoplastic resin layer is set to not less than 300 μm, preferably from 300 to 2000 μm and more preferably from 300 to 1000 μm.

If the thickness of the thermoplastic resin layer is less than 300 μm, it becomes difficult to embed the wiring in the resin. On the other hand, if thickness of the thermoplastic is too large, for example, if the thickness is set to 5000 μm or more, thermal conductivity to the thermocurable resin falls when the heat-pressing is performed.

The thermocurable resin layer is made of a thermocurable resin. A preferred example of the thermocurable resin is made of a thermocurable resin composition containing the following components:

(1) epoxy resin,

(2) a curing agent for the epoxy resin, and

(3) phenoxy resin.

It is preferred that the thermocurable resin does not have tackiness substantially even before the resin is cured. This is because the production process of the sheet for sealing bus-bars becomes simple.

Epoxy resin reacts with the curing agent at a raised temperature or ambient temperature, so as to make it possible to form a cured product having three-dimensional network structure. In this case, the cured product of the epoxy resin is superior in heat resistance and the like, and gives cohesive power to the adhesive layer so that objects to be adhered can be bonded to each other. As a result, the thermocurable resin layer is not easily stripped from the object to be adhered even if Joule heat is applied thereto by sending electric current to bus-bars.

The kind of the epoxy resin is not particularly limited if the resin can give heat resistance, the cohesive power and the like. Examples of such an epoxy resin include epoxy resins such as Bisphenol-A type epoxy resin, Bisphenol-F type epoxy resin, phenol novolak type epoxy resin, cresol novolak type epoxy resin, fluorene epoxy resin, glycidylamine resin, aliphatic epoxy, brominated epoxy, and fluorinated epoxy.

The above-mentioned epoxy resin is usually contained at a ratio of from 5 to 80% by weight in the thermocurable resin composition. If the content of the epoxy resin is less than 5% by weight, the heat resistance of the thermocurable resin deteriorates. On the other hand, if the content of the epoxy resin is more than 80% by weight, the cohesive power of the composition deteriorates and the fluidity thereof becomes excess. Preferably, the epoxy resin is contained at a ratio of 10 to 50% by weight in the thermocurable resin composition.

A curing agent is further added to the thermocurable resin composition, and the curing agent reacts with the epoxy resin to cure the composition thermally at a raised temperature or ambient temperature. The kind of the curing agent is not particularly limited as far as the agent can cure the composition thermally as described above. For example, the following curing agent can be used: an amine curing agent, acid anhydride, dicyanamide, imidazole, cationic polymerization catalysts, hydrazine compounds and the like. Dicyandiamide is particularly preferred from the viewpoint of thermal stability thereof at a room temperature (30° C.).

In addition, the curing agent is contained at a ratio of 0.1 to 30% by weight in the thermocurable resin composition. If the content by weight of the curing agent is less than 0.1% by weight, the curability of the resin composition deteriorates. If the content of the curing agent is more than 30% by weight, the insulating property of the thermocurable resin becomes poor. Preferably, the curing agent is contained at a ratio of 0.5 to 10% by weight in the thermocurable resin composition.

The phenoxy resin is a thermoplastic resin having chain structure, usually has a weight-average molecular weight of 2,000 to 2,000,000 or a number-average molecular weight of 10,000 to 1,000,000 and an epoxy equivalent of 500 to 500,000, and can give a suitable shape (for example, a film) to the composition. The phenoxy resin has structure similar to that of the above-mentioned epoxy resin and is compatible with it. This resin itself is shaped to be made up to an adhesive film. It is particularly preferred to use the phenoxy resin together with bisphenol A type epoxy resin or fluorene epoxy resin. This is because bisphenol A type epoxy resin or fluorene epoxy resin has very good compatibility with the phenoxy resin.

The thermocurable resin layer has a minimum storage shear modulus of 100,000 Pa or less, preferably 10 to 100,000 Pa. This is because even if such a thermocurable resin layer is heat-pressed, unintended flowing of the resin is not easily generated. In the step of sealing bus-bars, the heat-pressing is generally performed at a temperature of 60 to 260° C. and a pressure of 10⁴ to 5×10⁷ Pa.

On the other hand, if the minimum storage shear modulus is more than approximately 100,000, a very large pressure is necessary in order that the resin conceals the bus-bars. Thus, the pressing becomes difficult. The storage shear modulus (G′) in the present specification is a minimum value when a dynamic viscoelasticity meter (for example, “RDA II” manufactured by Reometrics Co.) is used to measure the shear modulus under an angular velocity of 6.28 rad/sec (frequency of 1 Hz) while the temperature is raised from 60 to 260° C. at a rate of 5° C. per minute.

The thermocurable resin layer may be made of a composition which contains a bismaleimide resin instead of the epoxy resin, or a composition which contains a bismaleimide resin in addition to the epoxy resin. Instead of the phenoxy resin or in addition to the phenoxy resin, various super engineer plastics, polyhydroxy ether obtained by reacting fluorene bisphenol with epoxy resin, or other thermoplastic resin may be used. Polyhydroxy ether into which the above-mentioned fluorene backbone is introduced is particularly preferred to improve the heat resistance and the water resistance of the thermocurable resin layer.

The thermocurable composition may be made of a composition mainly comprising epoxy resin, bismaleimide resin or a mixture thereof, and a curing agent for it without using the above-mentioned thermoplastic resin as far as the composition does not depart from the object and the effect of the present invention. A thermocurable resin made mainly of ethylene-glycidyl methacrylate copolymer is low in water absorption. Thus, the resin is suitable for use under environments having high humidity.

The thickness of the thermocurable resin layer is appropriately adjusted in such a manner that the layer can cause the end of the bus-bars to be securely and compactly bonded when the layer is heat-pressed. In general, the thickness of the thermocurable resin layer is set to 100 μm, preferably 5 to 100 μm, more preferably 10 to 50 μm.

If the thickness of the thermocurable resin layer is too thin, for example, if the thickness is less than 3 μm, the adhesiveness thereof becomes poor. Contrarily, if the thickness of the thermocurable resin layer is 100 μm or more, the thermocurable resin layer cannot easily be made uniform and the flowing-out of the thermocurable resin layer becomes considerable.

A given amount of a coating solution of the thermocurable resin is applied to one surface of a substrate subjected to releasing treatment, thereafter, the substrate is dried at a given temperature to make it possible to obtain a thermocurable resin layer supported by the releasable substrate. The thermocurable resin layer is released from this releasable substrate and then this layer is laminated on one surface of a thermoplastic resin layer, whereby a sheet for sealing bus-bars can be obtained. The laminating may be performed by a well-known method such as heat-pressing. The thermocurable resin layer may be formed by applying the coating solution directly to one surface of the thermoplastic resin layer and drying the solution.

The resultant sheet for sealing bus-bars is placed on the bus bar so that the thermocurable resin layer contacts bus-bars. The sheet for sealing bus-bars and the bus-bars are pressed with heating to adhere them to each other. Next, the thermoplastic resin is heated to be completely cured. In this way, bus-bars can be sealed.

### EXAMPLES

Production of an Adhesive Layer

A coating solution of a thermocurable resin was obtained by mixing the components shown in Table 1.

TABLE 1

| | Parts by |
|---|---|
| Component | weight |
| Phenoxy resin, “YP50S” made by Tohto Kasei Co., average | 30 |
| number molecular weight = 11,800 | |
| Epoxy resin, “DER332” made by Dow Chemical Japan Ltd., | 20 |
| epoxy equivalent = 174 | |
| Acrylic polymer dispersed epoxy resin, “Modiver RD102” | 20 |
| made by Nippon Oil Co., Ltd., acryl content = 40% by weight | |
| Epoxy resin, “PCL-G402” made by Daicel chemical Industries. | 30 |
| Ltd., epoxy equivalent = 1350 | |
| MEK sol of silica, “MEK-ST” made by Nissan Chemical | 50 |
| Industries, Ltd., silica content = 30% by weight | |
| Dicyandiamide | 2.9 |
| Toluene bisdimethylurea, “Omicure-24” made by PTI Japan Co. | 2.0 |
| Methanol | 40 |
| Methyl ethyl ketone | 40 |

A PET film (thickness: 50 μm) subjected to releasing treatment was coated with the obtained coating composition, and then the film was passed through an oven of 100 to 130° C. and dried to obtain a film adhesive agent having a thickness of 25 μm.

Production of a Sheet for Sealing Bus-Bars

The film adhesive agent was released from the PET film and placed on one surface of a polyethylene terephthalate film (“6010” manufactured by Takiron K.K.) having a thickness of 500 μm. The resultant was heat-laminated with a 100° C. roller to obtain a sheet for sealing bus-bars.

Method of Sealing Bus-Bars

As shown in FIG. 2, five pieces of bus-bars 4 having a size of 50×2×0.6 mm³ were arranged, in parallel to each other and at intervals of 3 mm, and one bus-bars was placed in the form of a T-character on a surface of a glass plate 3 having a size of 25×25×1 mm³. The sheet for sealing bus-bars was cut into a size of 25×25 mm³, and the cut sheet was placed on bus-bars arranged on the glass plate so that the thermocurable resin layer would contact the bus-bars. A silicone rubber having a thickness of 1 mm was placed on the sheet for sealing bus-bars. The resultant was pressed at 165° C. and 140 kgf for 20 seconds to obtain a structural body wherein the ends of bus-bars were sealed. FIG. 3 is a perspective view of this structural body. Thereafter, this structural body was put into an oven and heated at 130° C. for 1 hour.

The non-sealed ends of the bus-bars of the resultant structural body is pulled perpendicularly toward the surface of the glass plate so that the 90-degree releasing force thereof was measured. The 90-degree releasing force was 3 kgf The sealed ends of the bus-bars of the resultant structural body were immersed into water, and the structural body was allowed to stand still for 1 week. After the ends were pulled up from the water, the electric resistance between the adjacent bus-bars was measured. The resistance value was 1 megaohm or more.

In the sheet for sealing bus-bars of the present invention, a thermoplastic resin layer having a relatively large thickness and a thermocurable resin layer having a relatively small thickness are combined. When the sheet for sealing bus-bars having such a structure is used, bus-bars into which a large quantity of electric current flows can be easily and securely sealed by pressing with heating. Thus, bus-bars can be completely protected from humidity and corrosive atmosphere. Furthermore, when the sheet for sealing bus-bars of the present invention is used, bus-bars having a thickness of 0.5 mm or more can easily be sealed.

1. A sheet for sealing at least one bus-bar comprising a thermoplastic resin layer having a thickness of not less than 300 μm, and a thermocurable resin layer having a thickness of not more than 100 μm formed on one surface thereof.

2. The sheet for sealing at least one bus-bar according to claim 1, wherein the thermoplastic resin is selected from the group consisting of polyester, polyolefin, EVA, ethylene acrylate copolymer, acrylic resin, fluorine resin, and polyester.

3. The sheet for sealing at least bus-bar according to claim 1 or 2, wherein the thermocurable resin further comprises epoxy resin, phenoxy resin, or mixture thereof.

4. The sheet for sealing at least one bus-bar according to claim 2 wherein the epoxy resin is comprises from 5 to 80% by weight of the thermocurable resin composition.

5. A process for preparing a sheet for sealing at least one bus-bar comprising the step of laminating thermocurable resin film having a thickness of not more than 100 μm on one surface of thermoplastic resin film having a thickness of not less than 300 μm.

6. A process for sealing at least one bus-bar comprising the steps of:
placing the sheet for sealing bus-bar according to claim 1 on bus-bar so that the thermocurable resin layer contacts the bus-bar;
pressing the sheet for sealing bus-bar to the bus-bar with heating to adhere them to each other; and
heating the thermocurable resin to cure completely.

7. An electric circuit wherein electric wiring therein is sealed by using the sheet for sealing bus-bar according to any of claims 1 to 3.
